(19) United States
(12) Patent Application Publication
(10) Pub. No.: US 2025/0378170 A1
(43) Pub. Date: Dec. 11, 2025

(54) INFORMATION PROCESSING APPARATUS, INFORMATION PROCESSING SYSTEM, AND INFORMATION PROCESSING METHOD

(71) Applicant: Toshiba Tec Kabushiki Kaisha, Tokyo (JP)

(72) Inventor: Yoshihiro KOMATSUBARA, Mishima (JP)

(73) Assignee: Toshiba Tec Kabushiki Kaisha, Tokyo (JP)

(21) Appl. No.: 19/075,357

(22) Filed: Mar. 10, 2025

(30) Foreign Application Priority Data
Jun. 10, 2024 (JP) 2024-093581

(51) Int. Cl. G06F 21/57; G06F 21/12

(52) U.S. Cl. CPC G06F 21/57; G06F 21/121

(57) ABSTRACT

An information processing apparatus includes: an internal storage configured to store one or more programs; a controller configured to execute the one or more programs; and an interface configured to receive information from an external storage containing a whitelist. The whitelist includes determination information indicating whether to allow the controller to execute each of the one or more programs. The controller is configured to acquire the whitelist from the external storage through the interface, verify an integrity of the acquired whitelist, and in response to a determination that the acquired whitelist is complete, store the acquired whitelist in the internal storage as an active whitelist to be used for determining whether to allow the controller to execute each of the one or more programs stored in the internal storage.

### CROSS-REFERENCE TO RELATED APPLICATION

This application is based upon and claims the benefit of priority from Japanese Patent Application No. 2024-093581, filed on Jun. 10, 2024, the entire contents of which are incorporated herein by reference.

### FIELD

Embodiments described herein relate generally to an information processing apparatus, an information processing system, and an information processing method.

### BACKGROUND

When a program that operates in an information processing apparatus is executed, the information processing apparatus determines whether to execute the program using a whitelist. The whitelist is a list of sets each of which includes file path information and a hash value calculated from a program file regarding each of programs installed in the information processing apparatus.

In the information processing apparatus having this execution control using the whitelist, the whitelist is stored in an auxiliary storage device as an internal storage. As the auxiliary storage device, in general, an inexpensive storage device (for example, a Hard Disk Drive (HDD)) or a flash memory called an SD memory card) having low fault tolerance is adopted. In the auxiliary storage device that adopts the inexpensive storage device having low fault tolerance, the storage content may be damaged due to power interruption or the like of the information processing apparatus. When the whitelist is damaged, whether to execute the program cannot be determined.

JP-A-2010-238168 discloses that a whitelist is updated by downloading the whitelist from a server. Accordingly, when the whitelist is damaged in the information processing apparatus, it can be assumed that the whitelist is downloaded from a server and operated. However, even after the whitelist is downloaded, whether the downloaded whitelist itself is complete is not ensured at all. Therefore, when the downloaded whitelist is used instead of the damaged whitelist, there is a risk.

### DESCRIPTION OF THE DRAWINGS

FIG. 1 is a block diagram illustrating an example of a configuration of an information processing system according to a first embodiment;

FIG. 2 is a block diagram illustrating an example of a configuration of an image forming apparatus that is the information processing apparatus according to the first embodiment;

FIG. 3 is a schematic diagram illustrating an example of a registration content of a whitelist file stored in a whitelist file storage unit of the image forming apparatus;

FIG. 4 is a schematic diagram illustrating an example of an execution determination result based on a whitelist during execution of a program in the image forming apparatus;

FIG. 5 is a block diagram illustrating an example of a configuration of a whitelist server in FIG. 1;

FIG. 6 is a schematic diagram illustrating an example of a storage content of a model-based hash value storage unit of the whitelist server;

FIG. 7 is a sequence diagram illustrating a start-up operation of each of the image forming apparatuses in the information processing system;

FIG. 8 is a flowchart illustrating an example of a start-up process operation that is executed by a processor of the image forming apparatus;

FIG. 9 is a block diagram illustrating an example of a configuration of an image forming apparatus that is an information processing apparatus according to a second embodiment;

FIG. 10 is a sequence diagram illustrating a start-up operation of each of image forming apparatuses in an information processing system according to the second embodiment; and

FIG. 11 is a flowchart illustrating an example of a start-up process operation that is executed by a processor of the image forming apparatus according to the second embodiment.

### DETAILED DESCRIPTION

Embodiments provide an information processing apparatus, an information processing system, and an information processing method where, even when an inexpensive auxiliary storage device having low fault tolerance is used, a whitelist can be operated safely.

In general, according to one embodiment, an information processing apparatus includes: an internal storage configured to store one or more programs; a controller configured to execute the one or more programs; and an interface configured to receive information from an external storage containing a whitelist. The whitelist includes determination information indicating whether to allow the controller to execute each of the one or more programs. The controller is configured to acquire the whitelist from the external storage through the interface, verify an integrity of the acquired whitelist, and in response to a determination that the acquired whitelist is complete, store the acquired whitelist in the internal storage as an active whitelist to be used for determining whether to allow the controller to execute each of the one or more programs stored in the internal storage.

### First Embodiment

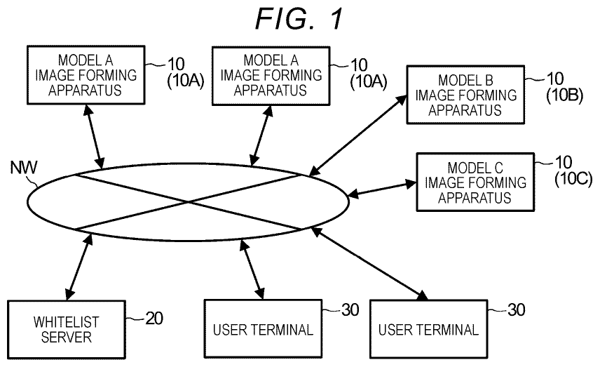

FIG. 1 is a block diagram illustrating an example of a configuration of an information processing system according to a first embodiment. The information processing system includes a plurality of image forming apparatuses 10, one whitelist server 20, and a plurality of user terminals 30 (e.g., user devices) that are connected through a network NW, for example, an in-house local area network (LAN). The image forming apparatuses 10 and the user terminal 30 are placed in a workplace. The whitelist server 20 is disposed in an environment having a higher security level than the image forming apparatus 10. The image forming apparatus 10 is an information processing apparatus according to the first embodiment, and may be, for example, a multi-function peripheral (hereinafter abbreviated as MFP) having at least a scanning function and a print function. The user terminal 30 is a personal computer or the like, and can transmit a print job to the image forming apparatus 10 to form an image or can receive document data scanned by the image forming apparatus 10 to display the received document data.

The image forming apparatus 10 can include different models of apparatuses. In the example of FIG. 1, the information processing system includes three models of image forming apparatuses 10 including a model A image forming apparatus 10A, a model B image forming apparatus 10B, and a model C image forming apparatus 10C, and a case where two model A image forming apparatuses 10A are present is illustrated. Of course, this configuration is an example, the number of models, the number of apparatuses of each of the models, and the total number of image forming apparatuses 10 are not limited to this example. Likewise, FIG. 1 illustrates two user terminals 30. However, the number of the user terminals 30 is not limited to this example.

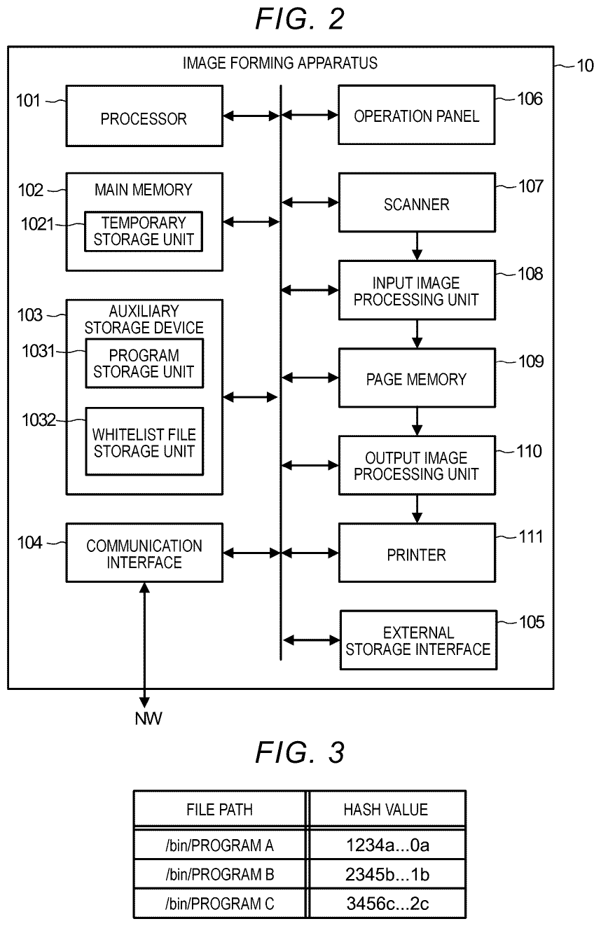

FIG. 2 is a block diagram illustrating an example of a configuration of each of the image forming apparatuses 10. As illustrated in FIG. 2, the image forming apparatus 10 includes a processor 101, a main memory 102, an auxiliary storage device 103, a communication interface 104, an external storage interface 105, an operation panel 106, a scanner 107, an input image processing unit 108, a page memory 109, an output image processing unit 110, a printer 111, and the like. These individual units are connected to each other through a data bus or the like. The image forming apparatus 10 may further include a configuration in addition to the configurations illustrated in FIG. 2 as necessary, or a specific configuration may be excluded from the configuration illustrated in FIG. 2.

The processor 101 (e.g., a controller) is, for example, a central processing unit (CPU), but is not limited thereto. The processor 101 may be a multi-core multi-thread CPU and can execute a plurality of processes in parallel. In addition, the processor 101 may be a micro processing unit (MPU). The processor 101 has a function of controlling an overall operation of the image forming apparatus 10. For example, the processor 101 may include an internal memory and various interfaces. The processor 101 implements various processes by executing programs stored in the internal memory, the auxiliary storage device 103, or the like in advance.

Further, a part of various functions that are implemented by the processor 101 executing the programs may be implemented by other various forms of hardware circuits including an integrated circuit such as an application specific integrated circuit (ASIC), a digital signal processor (DSP), a field-programmable gate array (FPGA), a graphics processing unit (GPU), a system on a chip (SoC), or a programmable logic device (PLD). In this case, the processor 101 controls the functions that are executed by the hardware circuit.

The main memory 102 is a volatile memory. The main memory 102 is a working memory or a buffer memory. The main memory 102 can store various application programs based on commands from the processor 101. In addition, the main memory 102 can include a temporary storage unit 1021 that stores data required for executing a control program or an application program stored in the auxiliary storage device 103, execution results of these programs, and the like.

The auxiliary storage device 103 is a nonvolatile internal storage capable of writing and rewriting data. As the auxiliary storage device 103, for example, an inexpensive storage device, such as an HDD, a solid state drive (SSD), or a flash memory, having low fault tolerance is adopted. The auxiliary storage device 103 stores a control program, an application program (e.g., an application), various data, and the like according to the operation and use of the image forming apparatus 10. For example, the auxiliary storage device 103 includes a program storage unit 1031 that stores the programs and a whitelist file storage unit 1032 that stores a whitelist file. The whitelist file will be described below. In addition, the auxiliary storage device 103 can store a print job (e.g., print job data) or the like transmitted from the user terminal 30. The print job includes print target data such as text data or image data based on which an image is formed on paper. The print target data may be data for forming an image on one sheet of paper or may be data for forming an image on plural sheets of paper. Further, the print job can include, as control data, information representing whether the printing is color printing or monochrome printing, and information such as the number of printing units (e.g., a number of page sets, a number of copies, etc.), and the number of printed sheets per unit.

The communication interface 104 (e.g., a network interface) is an interface for communication with the whitelist server 20 and the user terminal 30 that are external apparatuses (e.g., external devices) on the network NW. The communication interface 104 is configured with, for example, a LAN connector. In addition, the communication interface 104 may execute wireless communication with another apparatus in accordance with a standard such as Bluetooth (registered trademark) or Wi-Fi (registered trademark).

The external storage interface 105 may be a reader and writer of a removable computer-readable storage medium such as a universal serial bus (USB) memory.

The operation panel 106 (e.g., a user interface, an input and/or output device, etc.) inputs various instructions from an operator of the image forming apparatus 10. The operation panel 106 transmits a signal indicating the instruction input from the operator to the processor 101. The operation panel 106 includes, for example, a keyboard, a numeric keypad, and a touch panel as operation units. In addition, the operation panel 106 displays various information to the operator of the image forming apparatus 10. That is, the operation panel 106 displays a screen indicating various information based on a signal output from the processor 101. The operation panel 106 includes, for example, a monitor such as a liquid crystal display as a display unit (e.g., a display).

The scanner 107 optically scans an original document and reads an image of the original document as image data. The scanner 107 reads the original document as a color image. The scanner 107 is configured with, for example, a sensor array that is formed in a main scanning direction. The scanner 107 moves the sensor array in a sub-scanning direction to read the entire area of the original document.

The input image processing unit 108 processes the image data read from the scanner 107. In addition, the input image processing unit 108 may process image data read from a removable computer-readable storage medium by the external storage interface 105. Further, the input image processing unit 108 converts the print target data such as text data or image data in the print job stored in the auxiliary storage device 103 into image data representing an image to be formed.

The page memory 109 stores the image data processed by the input image processing unit 108.

The output image processing unit 110 (e.g., a function of the processor 101) processes the image data stored in the page memory 109 such that the printer 111 can print the image data on paper.

The printer 111 (e.g., an image forming unit) prints the image data processed by the output image processing unit 110 on paper based on a control from the processor 101. The printer 111 prints the image data on paper using, for example, an electrophotographic method.

FIG. 3 is a schematic diagram illustrating an example of a registration content of a whitelist file stored (e.g., contained) in the whitelist file storage unit 1032. The whitelist file can be implemented with, for example, a CSV format text file where information regarding the program stored in the program storage unit 1031 is one record. Each of the records includes: file path information of the program storage unit 1031 that is a storage destination of a program file of the corresponding program; and a hash value that is calculated from the program file. The data of the hash value may be, for example, a value calculated by a general hash function such as MD5 with the program file as an input. FIG. 3 shows an example where the program storage unit 1031 stores three programs (a program A, a program B, and a program C).

As described below, the whitelist file stored in the whitelist file storage unit 1032 is downloaded from the whitelist server 20 during start-up when the power of the image forming apparatus is turned on.

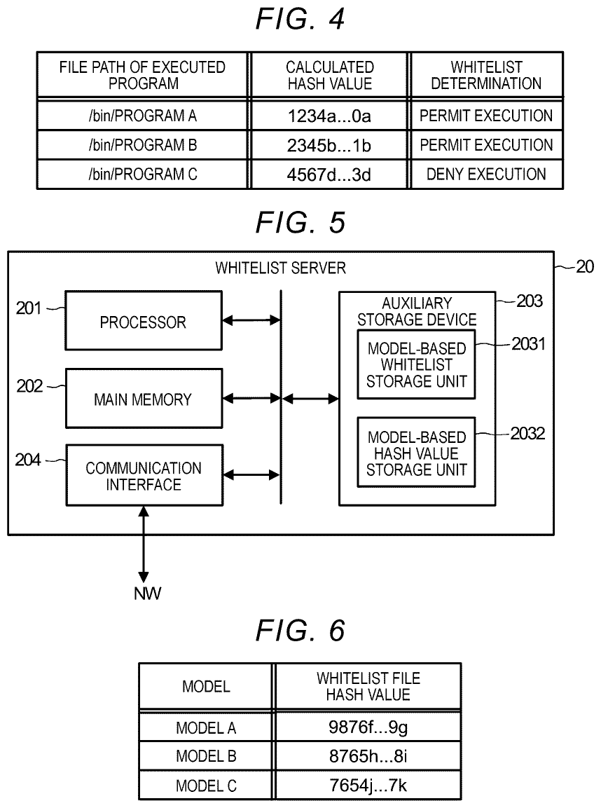

FIG. 4 is a schematic diagram illustrating an example of an execution determination result based on a whitelist during execution of a program in the processor 111. When a program of a program file stored in the program storage unit 1031 is executed, the processor 111 determines whether to execute the program based on a registration content of the whitelist file stored in the whitelist file storage unit 1032. Specifically, the processor 111 calculates a hash value from the program file of the program to be started, and checks whether a hash value corresponding to the program file stored in the whitelist file storage unit 1032 and the calculated hash value match with each other. When both of the hash values match with each other, the execution of the program is permitted. When both of the hash values mismatch with each other, the execution of the program is denied.

FIG. 5 is a block diagram illustrating an example of a configuration of the whitelist server 20. As illustrated in FIG. 5, the whitelist server 20 includes a processor 201, a main memory 202, an auxiliary storage device 203, a communication interface 204 (e.g., a network interface), and the like. These individual units are connected to each other through a data bus or the like.

The whitelist server 20 may further include a configuration in addition to the configurations illustrated in FIG. 5 as necessary, or a specific configuration may be excluded from the configuration illustrated in FIG. 5.

The processor 201 (e.g., a controller) is, for example, a CPU but is not limited thereto. The processor 201 may be a multi-core multi-thread CPU and can execute a plurality of processes in parallel. In addition, the processor 201 may be an MPU. The processor 201 has a function of controlling an overall operation of the whitelist server 20. For example, the processor 201 may include an internal memory and various interfaces. The processor 201 implements various processes by executing programs stored in the internal memory, the auxiliary storage device 203, or the like in advance. Further, a part of various functions that are implemented by the processor 201 executing the programs may be implemented by other various forms of hardware circuits including an integrated circuit such as an ASIC, a DSP, a FPGA, a GPU, a SoC, or a PLD. In this case, the processor 201 controls the functions that are executed by the hardware circuit.

The main memory 202 is a volatile memory. The main memory 202 is a working memory. The main memory 202 can store various application programs based on commands from the processor 201. In addition, the main memory 202 can store data required for executing a control program or an application program stored in the auxiliary storage device 203, execution results of these programs, and the like.

The auxiliary storage device 203 is a nonvolatile internal storage capable of writing and rewriting data. As the auxiliary storage device 203, an expensive storage device having excellent fault tolerance is used. For example, the auxiliary storage device 203 has high fault tolerance by adopting a high-quality storage device for a server, or even when an inexpensive storage device having low fault tolerance is used, by adopting a RAID configuration where a plurality of the storage devices are used. The auxiliary storage device 203 stores a control program, an application program, various data, and the like according to the operation and use of the whitelist server 20. For example, in addition to a program storage unit (not illustrated) that stores the program, the auxiliary storage device 203 includes a model-based whitelist storage unit 2031 and a model-based hash value storage unit 2032.

The model-based whitelist storage unit 2031 stores different whitelist files depending on models such as a whitelist file for the model A image forming apparatus 10A, a whitelist file for the model B image forming apparatus 10B, and a whitelist file for the model C image forming apparatus 10C. In other words, the same whitelist file is used for the same model. That is, in the same model, file paths of the program storage unit 1031 that is a storage destination of the program file are integrated. The registration content of the whitelist file for each of the models is the same as described above with reference to FIG. 3.

The model-based hash value storage unit 2032 stores different hash values depending on the models. FIG. 6 is a schematic diagram illustrating an example of the storage content of the model-based hash value storage unit 2032. As illustrated in FIG. 6, as a model-based hash value, the model-based hash value storage unit 2032 stores a whitelist file hash value that is a hash value of the whitelist file for each of the models stored in the model-based whitelist storage unit 2031. The data of the whitelist file hash value may be, for example, a value calculated by a general hash function such as MD5 with the model-based whitelist file as an input.

The storage contents of the model-based whitelist storage unit 2031 and the model-based hash value storage unit 2032 can be updated by a manager of the information processing system. For example, when a program is installed in any image forming apparatus 10, that is, when the program storage unit 1031 of the image forming apparatus 10 newly stores a program file, the manager generates a corresponding model-based whitelist file and a corresponding model-based hash value, and stores the generated model-based whitelist file and the generated model-based hash value in the model-based whitelist storage unit 2031 and the model-based hash value storage unit 2032 of the whitelist server 20. It should be noted that, when the same program is already installed in the same model of the image forming apparatuses 10, this operation is unnecessary. In addition, this operation is necessary not only when a program is newly installed but also when an installed program is updated. The reason for this is that the update of the hash value is necessary because, although the file path is not changed, the content of the program file is updated.

The communication interface 204 is an interface for communication with each of the image forming apparatuses 10 that are external apparatuses on the network NW. The communication interface 204 is configured with, for example, a LAN connector. In addition, the communication interface 204 may execute wireless communication with another apparatus in accordance with a standard such as Bluetooth or Wi-Fi.

Hereinafter, a start-up operation of each of the image forming apparatuses 10 in the information processing system having the above-described configuration will be described.

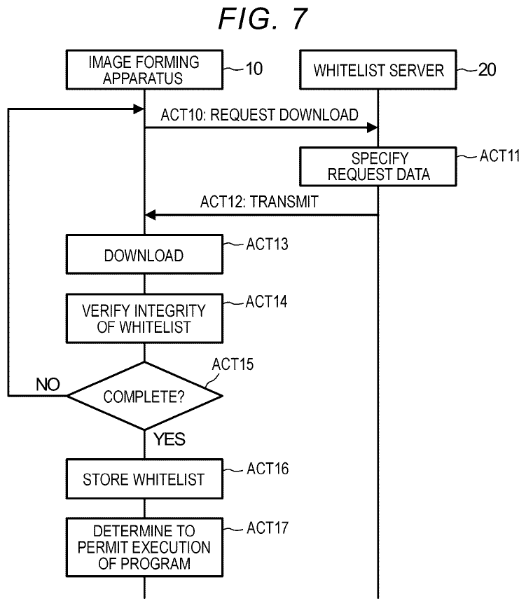

FIG. 7 is a sequence diagram illustrating the start-up operation of each of the image forming apparatuses 10 in the information processing system. When the power is turned on such that the image forming apparatus 10 starts, first, a download request is transmitted to the whitelist server 20 through the network NW (ACT 10).

In response to the download request, the whitelist server 20 specifies request data to be downloaded to the image forming apparatus 10 that is a requestor of the download request (ACT 11). Specifically, based on the model of the image forming apparatus 10 of the requestor, the whitelist server 20 specifies the whitelist file stored in the model-based whitelist storage unit 2031 and the whitelist file hash value stored in the model-based hash value storage unit 2032. the whitelist server 20 transmits the specified whitelist file to the image forming apparatus 10 of the requestor together with the specified whitelist file hash value (ACT 12).

The image forming apparatus 10 of the requestor downloads the whitelist file and the whitelist file hash value transmitted from the whitelist server 20 (ACT 13). The image forming apparatus 10 verifies the integrity of the downloaded whitelist file (ACT 14). Specifically, the image forming apparatus 10 calculates a hash value from the downloaded whitelist file, and compares the calculated hash value to the downloaded whitelist file hash value to verify the integrity of the downloaded whitelist file.

When the hash value calculated from the downloaded whitelist file and the downloaded whitelist file hash value do not match with each other (ACT 15: NO), that is, when the downloaded whitelist file is not complete, the image forming apparatus 10 repeats the process from ACT 10.

When the hash value calculated from the downloaded whitelist file and the downloaded whitelist file hash value match with each other (ACT 15: YES), that is, when the downloaded whitelist file is complete, the image forming apparatus 10 stores the downloaded whitelist file in the whitelist file storage unit 1032 (ACT 16) (e.g., as an active whitelist).

Using the whitelist file stored in the whitelist file storage unit 1032 (e.g., the active whitelist), the image forming apparatus 10 determines whether to permit execution of each of programs of an execution target stored in the program storage unit 1031 (ACT 17).

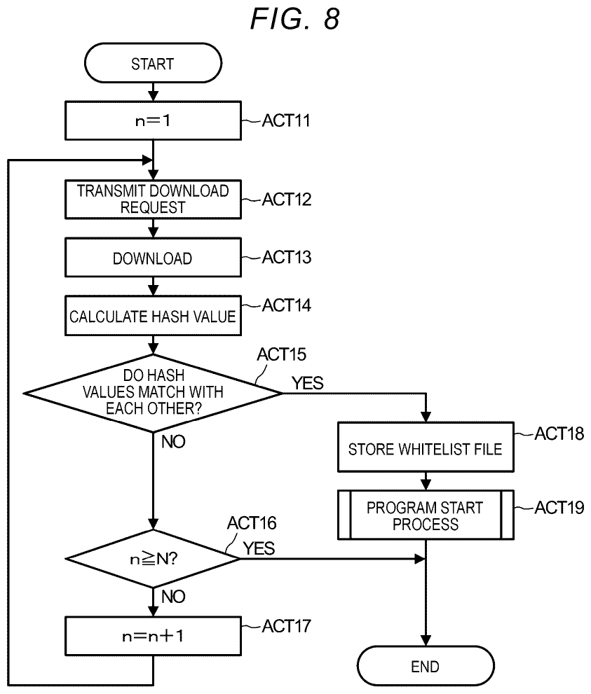

Hereinafter, an operation of the image forming apparatus 10 for implementing the above-described operation will be described. FIG. 8 is a flowchart illustrating an example of the start-up process operation that is executed by the processor 101 of the image forming apparatus 10. The processor 101 can execute this start-up process operation by executing an information processing program according to the first embodiment that is a control program stored in the auxiliary storage device 103. Unless specified otherwise, the process operation of the processor 101 illustrated in FIG. 8 proceeds to ACT (n+1) after ACT n (n represents a natural number). The procedure illustrated by FIG. 8 is an example. As long as the same result can be obtained, the procedure is not particularly limited.

In ACT 11, the processor 101 initializes the value of a counter n (not illustrated) provided in the processor 101 or in the main memory 102 to “1”.

In ACT 12, the processor 101 transmits a download request of the whitelist file to the whitelist server 20 through the network NW using the communication interface 104.

In ACT 13, in response to the download request, the processor 101 downloads data transmitted from the whitelist server 20 through the network NW using the communication interface 104. Specifically, the processor 101 receives a whitelist file for the model of the image forming apparatus 10 and a whitelist file hash value corresponding to the whitelist file, and temporarily stores the received whitelist file and the received whitelist file hash value in the temporary storage unit 1021.

In ACT 14, the processor 101 calculates a hash value from the whitelist file temporarily stored in the temporary storage unit 1021.

In ACT 15, the processor 101 compares the calculated hash value and the whitelist file hash value temporarily stored in the temporary storage unit 1021 to each other to determine whether both of the hash values match with each other. The processor 101 compares the hash values to each other to verify integrity of the downloaded whitelist file. When both of the hash values match with each other, the processor 101 determines YES in ACT 15, and proceeds to the process of ACT 18. When both of the hash values do not match with each other, the processor 101 determines NO in ACT 15, and proceeds to the process of ACT 16. For example, due to a problem such as noise on the network NW, there may be a situation that the whitelist file or the whitelist file hash value is not completely downloaded.

In ACT 16, the processor 101 determines whether the value of the counter n is a defined value N or more, that is, whether downloading is executed a defined number of times or more. When the value of the counter n is less than the defined value N, the processor 101 determines NO in ACT 16 and proceeds to the process of ACT 17. When the value of the counter n is the defined value N or more, the processor 101 determines YES in ACT 16, and ends the start-up process operation illustrated in this flowchart. In a situation that the integrity of the downloaded whitelist file is not verified even after repeating downloading the defined number of times or more, not a problem on the network NW but a problem on the whitelist server 20 side is assumed. This way, even when the integrity of the downloaded whitelist file is not verified even after repeating downloading the defined number of times or more, the processor 101 may execute a predefined error process, for example, may allow the operation panel 106 to display error.

In ACT 17, the processor 101 adds “+1” to the value of the counter n. Next, the processor 101 proceeds to the process of ACT 12.

In ACT 18, the processor 101 stores the whitelist file temporarily stored in the temporary storage unit 1021 in the whitelist file storage unit 1032.

In ACT 19, the processor 101 executes a program start-up process. In the program start-up process, using the whitelist file stored in the whitelist file storage unit 1032, the processor 101 determines whether to permit execution of each of programs of an execution target stored in the program storage unit 1031. The processor 101 starts the program of which the execution is determined to be permitted. In addition, the processor 101 does not start the program of which the execution is determined to be denied. At this time, the processor 101 can allow the operation panel 106 to display error representing the program that does not start.

When the process on all of the programs of the execution target stored in the program storage unit 1031 ends, the processor 101 ends the start-up process operation illustrated in this flowchart.

As described above, the information processing system according to the first embodiment includes the image forming apparatus 10 and the whitelist server 20. The image forming apparatus 10 includes the program storage unit 1031 of the auxiliary storage device 103 that stores one or more programs, the processor 101 that executes the programs, and the communication interface 104. The whitelist server 20 stores a whitelist that is a list of sets each of which includes file path information of the program and a hash value calculated from the program to determine whether to allow the processor 101 of the image forming apparatus 10 to execute each of one or more programs stored in the program storage unit 1031. This way, the image forming apparatus 10 is an example of the information processing apparatus according to the first embodiment, the program storage unit 1031 is an example of the internal storage, the set including the file path information and the hash value is an example of the determination information, the whitelist server 20 is an example of the external storage, and the communication interface 104 of the image forming apparatus 10 is an example of the interface to the external storage. The processor 101 of the image forming apparatus 10 acquires a whitelist from the whitelist server 20 through the communication interface 104, verifies integrity of the acquired whitelist, and when the acquired whitelist is complete, stores the acquired whitelist in the whitelist file storage unit 1032 of the auxiliary storage device 103 as a whitelist used for determining whether to execute the program when any of the one or more programs stored in the program storage unit 1031 is executed.

This way, in the information processing system and the information processing apparatus according to the first embodiment, instead of the whitelist stored in the image forming apparatus 10 as the information processing apparatus, the whitelist downloaded from the whitelist server 20 is used after verifying the integrity thereof. Therefore, even when the inexpensive auxiliary storage device 103 having low fault tolerance is used, the image forming apparatus 10 can operate the whitelist safely. Here, “the inexpensive auxiliary storage device” refers to “an auxiliary storage device for a non-server application where data loss is likely to occur due to power interruption”. Accordingly, in the information processing system and the information processing apparatus according to the first embodiment, even when the whitelist stored in the auxiliary storage device 103 is falsified or damaged, functional breakdown can be prevented.

Here, when the whitelist is acquired, the processor 101 acquires a whitelist file hash value that is a hash value of the whitelist from the whitelist server 20 that is the external storage through the communication interface 104. The whitelist file hash value is an example of the verification information that is generated based on the content of the whitelist to verify integrity of the whitelist. When verifying the integrity of the whitelist, the processor 101 generates a whitelist file hash value that is the verification information based on the content of the acquired whitelist, and determines the integrity of the whitelist based on whether or the generated whitelist file hash value matches with the acquired whitelist file hash value. Accordingly, in the first embodiment, the integrity can be easily determined using the hash values.

In addition, during start-up of the image forming apparatus 10, the processor 101 acquires the whitelist and verifies the acquired whitelist. Accordingly, in the first embodiment, when the information processing apparatus is used and starts, the operation of the whitelist can be safely ensured.

### Second Embodiment

In the first embodiment, whenever the power is turned on such that the image forming apparatus 10 that is the information processing apparatus starts, the whitelist file is downloaded. However, the whitelist may also be downloaded as necessary. Hereinafter, this configuration will be described as a second embodiment. The same configurations and operations as those of the first embodiment are represented by the same reference numerals as those of the first embodiment, and the description thereof will not be repeated.

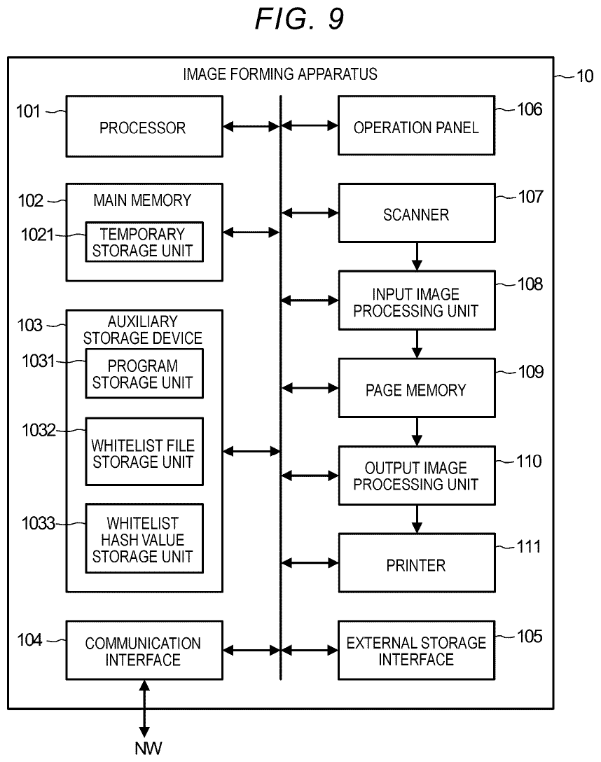

FIG. 9 is a block diagram illustrating an example of a configuration of an image forming apparatus 10 that is an information processing apparatus according to the second embodiment in an information processing system according to the second embodiment. As illustrated in FIG. 9, the image forming apparatus 10 according to the present embodiment further includes a whitelist hash value storage unit 1033 in the auxiliary storage device 103. The whitelist hash value storage unit 1033 stores a whitelist file hash value calculated from the whitelist file stored in the whitelist file storage unit 1032.

Hereinafter, a start-up operation of each of the image forming apparatuses 10 in the information processing system having the above-described configuration will be described.

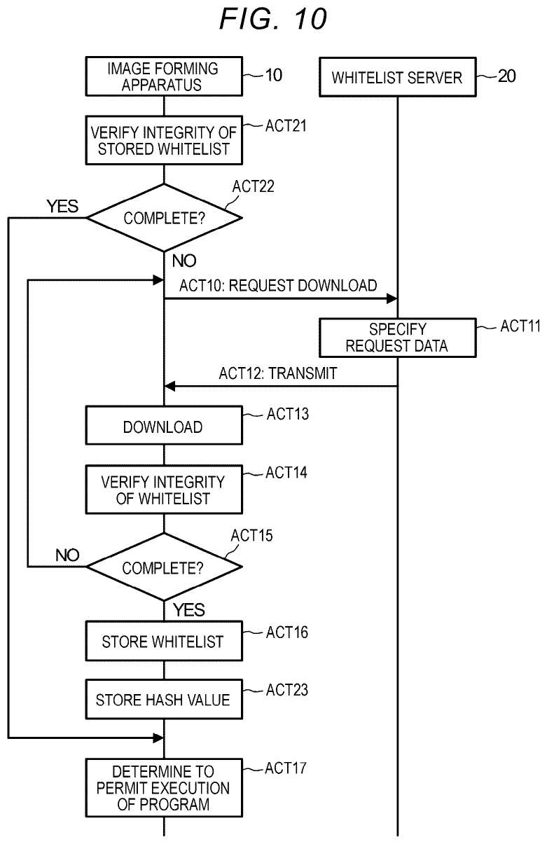

FIG. 10 is a sequence diagram illustrating a start-up operation of each of the image forming apparatuses 10 according to the second embodiment. When the power is turned on such that the image forming apparatus 10 starts, in the present embodiment, first, the integrity of the whitelist file stored in the whitelist file storage unit 1032 (e.g., an initial whitelist) is verified (ACT 21). Specifically, the image forming apparatus 10 calculates a hash value from the whitelist file stored in the whitelist file storage unit 1032. Then, the image forming apparatus 10 compares the calculated hash value to the whitelist file hash value stored in the whitelist hash value storage unit 1033 to verify the integrity of the whitelist file stored in the whitelist file storage unit 1032.

When the hash value calculated from the whitelist file stored in the whitelist file storage unit 1032 and the whitelist file hash value stored in the whitelist hash value storage unit 1033 match with each other (ACT 22: YES), that is, when the whitelist file stored in the whitelist file storage unit 1032 is complete, the image forming apparatus 10 proceeds to ACT 17.

On the other hand, when the hash value calculated from the whitelist file stored in the whitelist file storage unit 1032 and the whitelist file hash value stored in the whitelist hash value storage unit 1033 do not match with each other (ACT 22: NO), that is, when the whitelist file stored in the whitelist file storage unit 1032 is not complete, the image forming apparatus 10 executes the operation of ACT 10 to ACT 15 described in the first embodiment.

In ACT 15, when the hash value calculated from the downloaded whitelist file and the downloaded whitelist file hash value match with each other (ACT 15: YES), that is, when the downloaded whitelist file is complete, in ACT 16, the image forming apparatus 10 stores the downloaded whitelist file in the whitelist file storage unit 1032. In addition, the image forming apparatus 10 stores the downloaded whitelist file hash value or the hash value calculated for verifying the integrity of the downloaded whitelist file in ACT 14 in the whitelist hash value storage unit 1033 as the whitelist file hash value (ACT 23). The whitelist file storage unit 1032 and the whitelist hash value storage unit 1033 store the whitelist file and the whitelist file hash value in a nonvolatile manner. Accordingly, the whitelist file and the whitelist file hash value that are stored when the power is turned on such that the image forming apparatus 10 starts are data stored in ACT 16 and ACT 23. Next, the image forming apparatus 10 proceeds to ACT 17.

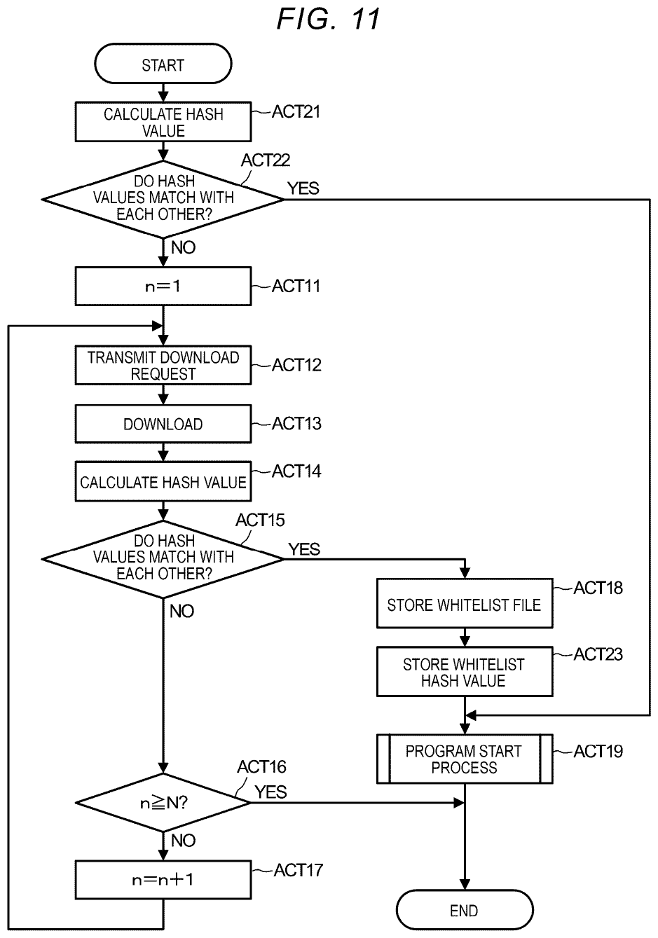

Hereinafter, an operation of the image forming apparatus 10 for implementing the above-described operation will be described. FIG. 11 is a flowchart illustrating an example of a start-up process operation that is executed by the processor 101 of the image forming apparatus 10 according to the second embodiment.

In the present embodiment, in ACT 21, the processor 101 calculates a hash value. Specifically, the processor 101 calculates a hash value from the whitelist file stored in the whitelist file storage unit 1032.

In ACT 22, the processor 101 compares the calculated hash value and the whitelist file hash value stored in the whitelist hash value storage unit 1033 to each other to determine whether both of the hash values match with each other. The processor 101 compares the hash values to each other to verify integrity of the whitelist file stored in the whitelist file storage unit 1032. When both of the hash values match with each other, the processor 101 determines YES in ACT 22, and proceeds to the process of ACT 19.

On the other hand, when both of the hash values do not match with each other, the processor 101 determines NO in ACT 22, and proceeds to the process of ACT 11. For example, the whitelist file or the whitelist file hash value stored in the whitelist file storage unit 1032 or the whitelist hash value storage unit 1033 may be falsified or damaged.

In addition, when the hash value calculated from the downloaded whitelist file and the downloaded whitelist file hash value match with each other such that the processor 101 determines YES in ACT 15 and proceeds to the process of ACT 18, the downloaded whitelist file is stored in the whitelist file storage unit 1032 in the process of ACT 18, and subsequently proceeds to the process of ACT 23 in the present embodiment.

In ACT 23, the processor 101 stores, in the whitelist hash value storage unit 1033, the whitelist file hash value that is downloaded and temporarily stored in the temporary storage unit 1021 or the hash value calculated, in ACT 14, from the whitelist file that is downloaded and temporarily stored in the temporary storage unit 1021. The whitelist file hash value stored in the whitelist hash value storage unit 1033 is an example of the verification information for verifying the integrity of the whitelist file stored in the whitelist file storage unit 1032.

In the process of ACT 18 and ACT 23, the whitelist file and the whitelist file hash value stored in the whitelist file storage unit 1032 and the whitelist hash value storage unit 1033 in a nonvolatile manner are updated. Next, the processor 101 proceeds to the process of ACT 19.

As described above, in the information processing system and the information processing apparatus according to the second embodiment, the image forming apparatus 10 that is an example of the information processing apparatus stores a whitelist file hash value in the whitelist hash value storage unit 1033 of the auxiliary storage device 103 that is the internal storage, the whitelist file hash value being verification information, for verifying the integrity of the whitelist, generated based on the whitelist file stored in the whitelist file storage unit 1032. During start-up of the image forming apparatus 10, the processor generates a whitelist file hash value based on the whitelist stored in the whitelist file storage unit 1032, and when the generated whitelist file hash value mismatches with the whitelist file hash value stored in the whitelist hash value storage unit 1033, acquires the whitelist from the whitelist server 20 through the communication interface 104 to verify the integrity of the acquired whitelist. When the acquired whitelist is complete, the processor 101 updates the whitelist and the whitelist file hash value stored in the whitelist file storage unit 1032 and the whitelist hash value storage unit 1033 with the acquired whitelist and the generated whitelist file hash value or with the generated whitelist file hash value.

This way, in the second embodiment, during the start-up of the image forming apparatus 10, the integrity of the whitelist stored in the whitelist file storage unit 1032 is verified based on the hash value calculated from the whitelist file and the whitelist file hash value stored in the whitelist hash value storage unit 1033. Only when the verification fails, the whitelist file and the whitelist file hash value are downloaded from the whitelist server 20. Accordingly, in the second embodiment, only when the whitelist in the image forming apparatus 10 is damaged, the communication with the whitelist server 20 is executed, and when the whitelist is not damaged, the start-up time can be shortened.

Even in the second embodiment, as in the first embodiment, the whitelist downloaded from the whitelist server 20 is used after verifying the integrity thereof. Therefore, even when the inexpensive auxiliary storage device 103 having low fault tolerance is used, the image forming apparatus 10 can operate the whitelist safely.

### Other Embodiments

Hereinabove, the embodiments of the information processing system and the information processing apparatus are described. However, the embodiments are not limited to this description.

For example, the image forming apparatus 10 that is an MFP is described as an example of the information processing apparatus. The information processing apparatus may be an office machine such as a point of sale (POS) terminal.

In addition, when the whitelist file and the whitelist file hash value are acquired from the external storage, the image forming apparatus 10 executes the acquisition from the whitelist server 20 as the external storage through the network NW using the communication interface 104. The external storage that stores the whitelist file and the whitelist file hash value may be any of the user terminals 30.

Further, the external storage may be a removable computer-readable storage medium such as an USB memory. In this case, the processor 101 can read and acquire the whitelist file and the whitelist file hash value from the computer-readable storage medium through the external storage interface 105 that is an interface of the external storage.

In addition, the external storage may be a paper medium where the whitelist file and the whitelist file hash value are described in an image (e.g., as a text or as a symbol image such as a barcode). In this case, using the scanner 107 that is an interface of the external storage, the processor 101 can read and acquire the whitelist file and the whitelist file hash value from the paper medium.

This way, in the present specification, the acquisition of the whitelist or the like from the external storage refers to not only downloading but also reading or scanning.

In addition, in the above description, the program stored in the program storage unit 1031 is stored in the same file path for the same model of image forming apparatuses 10. However, individual apparatuses may be stored in different file paths. In this case, depending on individual apparatuses, the external storage may store the whitelist file and the whitelist file hash value in association with the information that specifies the apparatus.

In addition, the flow of the information processing that is executed by the processor 101 described with reference to the flowchart is an example, and is not limited to this order. As long as there is no discrepancy occurring between the previous and subsequent processes, the order of the processes may be changed, or a plurality of processes may be executed in parallel.

In the above-described embodiments, the auxiliary storage device 103 of the image forming apparatus 10 previously stores the information processing program as a control program. Regarding this point, a control program that is transferred independently of the image forming apparatus 10 may be written into a writable storage device in the image forming apparatus 10 in response to an operation of a manager or the like. The control program or the like can be transferred by recording the control program or the like in a removable computer-readable storage medium or by communication through a network. The form of the computer-readable storage medium is not limited as long as the program can be stored and can be read by the device, for example, a CD-ROM or a memory card.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an internal storage configured to store one or more programs;
a controller configured to execute the one or more programs; and
an interface configured to receive information from an external storage containing a whitelist, the whitelist including determination information indicating whether to allow the controller to execute each of the one or more programs,
wherein the controller is configured to:
acquire the whitelist from the external storage through the interface;
verify an integrity of the acquired whitelist; and
in response to a determination that the acquired whitelist is complete, store the acquired whitelist in the internal storage as an active whitelist to be used for determining whether to allow the controller to execute each of the one or more programs stored in the internal storage.

2. The information processing apparatus of claim 1, wherein the controller is further configured to:
receive a request to execute a first program of the one or more programs; and
execute the first program in response to a determination that the active whitelist indicates that execution of the first program is permitted.

3. The information processing apparatus of claim 1, wherein the controller is further configured to:
receive a request to execute a first program of the one or more programs; and
prevent execution of the first program in response to a determination that the active whitelist indicates that execution of the first program is not permitted.

4. The information processing apparatus of claim 1, wherein the controller is configured to:
acquire first verification information from the external storage through the interface;
generate second verification information based on a content of the acquired whitelist; and
verify the integrity of the acquired whitelist based on whether the first verification information matches the second verification information.

5. The information processing apparatus of claim 4, wherein the controller is configured to verify the integrity of the acquired whitelist when the acquired whitelist is acquired from the external storage.

6. The information processing apparatus of claim 4, wherein the controller is configured to generate the second verification information by calculating the second verification information using a hash function with the acquired whitelist as an input.

7. The information processing apparatus of claim 1, wherein the controller is configured to acquire the whitelist and verify the acquired whitelist during start-up of the information processing apparatus.

8. The information processing apparatus of claim 1, wherein the internal storage is configured to store an initial whitelist and first verification information; and
wherein, during start-up of the information processing apparatus, the controller is configured to:
generate second verification information based on the initial whitelist stored in the internal storage; and
in response to a determination that the second verification information mismatches with the first verification information stored in the internal storage, acquire the whitelist from the external storage through the interface.

9. The information processing apparatus of claim 8, wherein the controller is configured to, in response to the determination that the acquired whitelist is complete, store the acquired whitelist in the internal storage as the active whitelist and store third verification information based on the acquired whitelist in the internal storage.

10. The information processing apparatus of claim 9, wherein the controller is configured to generate the third verification information based on the acquired whitelist.

11. The information processing apparatus of claim 9, wherein the controller is configured to acquire the third verification information from the external storage through the interface.

12. The information processing apparatus of claim 8, wherein the controller is configured to generate the second verification information by calculating the second verification information using a hash function with the initial whitelist as an input.

13. The information processing apparatus of claim 1, wherein the information processing apparatus is at least one of an image forming apparatus or a point of sale terminal.

14. The information processing apparatus of claim 1, wherein the external storage includes at least one of a server, a user device, or a removable computer-readable storage medium.

15. The information processing apparatus of claim 1, wherein the interface is configured to receive the information from the external storage through a network.

16. The information processing apparatus of claim 1, wherein the external storage contains the whitelist in an image, and wherein the interface is a scanner configured to read the whitelist from the image.

17. An information processing system comprising:
an information processing apparatus including an internal storage configured to store one or more programs and a controller configured to execute the one or more programs; and
an external storage containing a whitelist that includes determination information indicating whether to allow the controller of the information processing apparatus to execute each of one or more programs stored in the internal storage,
wherein the controller of the information processing apparatus is configured to:
acquire the whitelist from the external storage;
verify an integrity of the acquired whitelist; and
in response to a determination that the acquired whitelist is complete, store the acquired whitelist in the internal storage as an active whitelist to be used for determining whether to allow the controller to execute each of the one or more programs stored in the internal storage.

18. The information processing system of claim 17, wherein the external storage includes at least one of a server, a user device, or a removable computer-readable storage medium.

19. The information processing system of claim 17, wherein the external storage displays an image containing the whitelist, and wherein the information processing apparatus includes a scanner configured to read the whitelist from the image.

20. An information processing comprising:
acquiring, by a controller of an information processing apparatus, a whitelist from an external storage, the whitelist including determination information indicating whether to allow the controller to execute a program stored in an internal storage of the controller;
verifying, by the controller, an integrity of the acquired whitelist; and
in response to a determination that the acquired whitelist is complete, storing, by the controller, the acquired whitelist in the internal storage as an active whitelist to be used for determining whether to allow the controller to execute the program.
